(19) United States
(12) Patent Application Publication
(10) Pub. No.: US 2024/0297413 A1
(43) Pub. Date: Sep. 5, 2024

(54) METHOD FOR FORMING AN ELECTRICALLY CONDUCTIVELY FORMED CONNECTION AND BATTERY MODULE

(71) Applicant: Robert Bosch GmbH, Stuttgart (DE)

(72) Inventors: Ralph Glemser, Brackenheim (DE); Markus Schmitt, Tamm (DE); Silvio Grund, Wurzen (DE)

(21) Appl. No.: 18/585,831

(22) Filed: Feb. 23, 2024

(30) Foreign Application Priority Data
Mar. 2, 2023 (DE) 10 2023 201 891.8

(51) Int. Cl. H01M 50/507; H01M 10/42; H01M 50/204

(52) U.S. Cl. CPC H01M 50/507; H01M 10/425; H01M 50/204

(57) ABSTRACT

A method for forming an electrically conductively formed connection between a first power bus, which is electrically conductively connectable or connected to a voltage tap of a terminally arranged battery cell of a plurality of electrically conductively interconnected battery cells, and a second power bus, which is electrically conductively connected to a control unit of a battery module. The plurality of battery cells, the control unit, and the first power bus and the second power bus are accommodated in a housing of the battery module. An opening is provided in the housing, and an assembly aid is inserted into the opening. A connecting element is accommodated in the mounting aid, and a mechanical connection is formed between the first power bus and the second power bus by the connecting element, such that an electrically conductively formed connection is formed between the first power bus and the second power bus.

### BACKGROUND

The invention proceeds from a method for forming an electrically conductively formed connection between a first power bus and a second power bus.

Another object of the present invention is a battery module.

A battery module comprises a plurality of individual battery cells, each comprising a positive voltage tap and a negative voltage tap, in which case the respective voltage taps are electrically conductively connected to one another and thereby able to be connected to the battery module in an electrically conductive serial and/or parallel connection of the plurality of battery cells. In particular, the battery cells can each comprise a first voltage tap, in particular a positive voltage tap, and a second voltage tap, in particular a negative voltage tap, which taps are electrically conductively connected to one another by means of cell connectors so that an electrically conductive serial and/or parallel circuitry is formed. Battery modules are themselves in turn interconnected into batteries or entire battery systems.

The prior art in this respect includes, for example, the publications WO 2021-256 673 A1 or KR 2021-005 607 4 A.

### SUMMARY

A method for forming an electrically conductively formed connection between a first power bus and a second power bus offers the advantage that such a connection can reliably be mechanically and thus also electrically conductive.

According to the present invention, a method for forming an electrically conductively formed connection between a first power bus and a second power bus is provided for this purpose.

The first power bus is electrically conductively connectable or connected to a voltage tap of a terminally arranged battery cell of a plurality of battery cells. Furthermore, the plurality of battery cells are electrically conductively connected in series and/or in parallel to each other.

Furthermore, the second power bus is electrically conductively connectable or connected to a control unit of a battery module.

The plurality of battery cells, the control unit of the battery module as well as the first power bus and the second power bus are accommodated in a housing of the battery module.

Furthermore, an opening is provided in the housing. A mounting aid is inserted into the opening. Furthermore, a connecting element is accommodated in the mounting aid. By means of the connecting element, a mechanical connection between the first power bus and the second power bus is formed in such a manner that an electrically conductively formed connection between the first power bus and the second power bus is formed.

It should first be noted at this point that the first power bus and the second power bus are made of an electrically conductively formed material, such as in particular a metallic material, such as aluminum, copper, and/or nickel.

It should be noted at this point that the first power bus is connectable or connected to the voltage tap of the terminally arranged battery cell of the plurality of battery cells, particularly preferably by means of laser welding in a material-locking manner. It should also be noted at this point that the second power bus is connectable or connected to the control unit of the battery module by means of laser welding, particularly preferably with the aid of a welding pad arranged on a circuit board.

In particular, the mechanical connection between the first power bus and the second power bus and thus also the electrically conductively formed connection between the first power bus and the second power bus must be formed through the opening of the housing or inside the opening of the housing of the battery module. In other words, this means that the mechanical connection, for example, is formed within the housing of the battery module.

It is particularly expedient when the opening is arranged continuously through the housing. As a result, a reliable arrangement of the mounting aid in the opening can be formed.

It has proven advantageous for the mounting aid to be inserted into the opening in such a way that the mounting aid rests against the first power bus and/or the second power bus. This offers the particular advantage that it can prevent or at least reduce the possibility of particles that emerge during the connection process from entering an interior of the housing of the battery module. Particles that emerge remain within the assembly aid until this assembly aid is returned to an environment. In such an environment, the emerged particles may be reliably removed.

The mounting aid is configured as a mounting sleeve. In this case, the mounting aid can be inserted into the opening in such a way that an end face of the mounting aid rests over the entire service of the first power bus and/or the second power bus. In particular, the first power bus and the second power bus are not configured to be completely rigid, but are flexible within certain limits, whereby the mounting aid configured as a mounting sleeve can be pushed against the first power bus and/or the second power bus within certain limits in such a way that it reliably rests over the entire surface of the first power bus or the second power bus. In particular, a mounting sleeve comprises a cylindrical base body, which also has cylindrical formed opening, such as a bore, in a longitudinal direction of the mounting sleeve.

At this point it is noted that the end face of the mounting aid and in particular the mounting sleeve is configured in such a way that the end face makes complete or full mechanical contact with the first power bus and/or the second power bus, such that the formation of gaps, clearances, or openings between the mounting aid or the mounting sleeve and the first power bus or the second power bus, through which particles could possibly enter the interior of the housing of the battery module, are prevented.

Thus, a method according to the invention can reliably prevent possible emerging particles, which could possibly be electrically conductive, from entering an interior of the housing of the battery module during the assembly process and causing damage there, for example due to short circuits on a printed circuit board or the plurality of battery cells. Particles in the interior of the housing of the battery module that emerge from and/or during the connection process can therefore be reliably prevented.

In addition, the mechanical contact of the mounting aid, in particular the full-surface contact of the mounting sleeve, with the first power bus and/or on the second power bus, makes it possible to prevent the connecting element from falling into the interior of the housing of the battery module in the event of errors in the connection process, and as a result the battery module may no longer be able to be used.

Particularly preferably, the connecting element is configured as a screwing element, which engages a thread to form the mechanical connection. In particular, a screwing element can be inserted into the mounting sleeve in a particularly simple manner. The screwing element may, for example, be designed as a screw, which in particular comprises a screw head and a thread.

It should be noted at this point that by pushing the mounting aid, which is configured as a mounting sleeve, against the first power bus and/or against the second power bus, tolerances between the first power bus and the second power bus may also be compensated for during the screwing process without damaging the other electrical connections. This means that tolerances that interfere with the connection can be prevented.

Furthermore, it should be noted that in particular it is possible to prevent the screwing element from falling into the interior of the housing of the battery module in the event of errors in the connection process.

According to a preferred aspect of the invention, a cap nut forms the thread. The first power bus and the second power bus are arranged between the cap nut and the mounting aid, in particular the mounting sleeve. In particular, the screwing element can be guided through an opening or a recess of the first power bus and through an opening or a recess of the second power bus and engage in the thread of the cap nut. By tightening the screw element, the first power bus and the second power bus are mechanically contacted between a head element, in particular a screw head, the screwing element, and the cap nut. This offers the particular advantage that a mechanical contact can be formed in a particularly reliable manner.

According to another preferred aspect of the invention, the first power bus and/or the second power bus form the thread. In particular, the screwing element can be guided through an opening or a recess of the first power bus and engage in the thread of the second power bus. In particular, the screwing element could also be guided through an opening or a recess of the second power bus and engage in the thread of the second power bus. In particular, the screwing element could alternatively also engage in a thread of the first power bus and a thread of the second power bus. The first power bus and the second power bus may then be mechanically contacted by tightening the screwing element. This offers the particular advantage that a mechanical contact can be formed in a particularly reliable manner.

It is expedient if a first securing element of the mounting aid and a second securing element of the first power bus and/or the second power bus interlock in a manner that does not exceed a permissible tightening torque. In particular, it is possible to prevent damage to the further connections, for example the welded connections, by using such a support.

Preferably the first securing element is configured as the securing pin and the second securing element is configured as the recess.

It should also be noted that after a mechanical connection has been made, the mounting aid can preferably be removed from the opening again.

Finally, it should be noted that the opening of the housing of the battery module is closed after the connection process has been completed, for example by means of a closing element, such as a cover in particular.

The subject matter of the present invention is also a battery module with a plurality of battery cells and a control unit. Furthermore, the battery module comprises a first power bus and a second power bus.

The plurality of battery cells and the control unit as well as the first power bus and the second power bus are all accommodated in a housing of the battery module. The first power bus is electrically conductively connectable or connected to a voltage tap of a terminally arranged battery cell of a plurality of electrically conductively interconnected battery cells. Furthermore, the second power bus is electrically conductively connectable or connected to the control unit of the battery module. Furthermore, an opening is provided in the housing. The opening is configured to introduce a mounting aid as described above. A connecting element also forms a mechanical connection between the first power bus and the second power bus in such a manner that an electrically conductively formed connection between the first power bus and the second power bus is formed.

### BRIEF DESCRIPTION OF THE DRAWINGS

Exemplary embodiments of the invention are illustrated in the drawings and explained in greater detail in the subsequent description.

The drawings show:

FIG. 1 a perspective view of an embodiment of a battery module according to the invention,

FIG. 2 a sectional view of a battery module prior to the formation of the electrically conductively formed connection,

FIG. 3 a perspective view of the essential elements of the method for forming an electrically conductively formed connection,

FIG. 4 a screwing process for forming the mechanical connection,

FIG. 5 a first power bus and a second power bus prior to forming the mechanical connection, and

FIG. 6 a screwing process for forming the mechanical connection.

### DETAILED DESCRIPTION

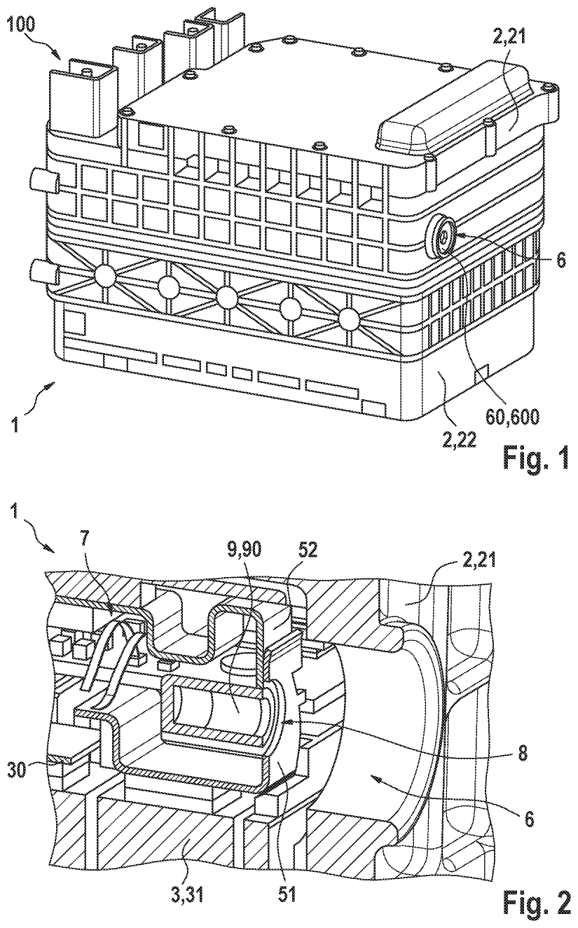

FIG. 1 shows a perspective view of an embodiment of a battery module 1.

The battery module 1 comprises a housing 2, which comprises a first housing element 21 and a second housing element 22. In this case, the first housing element 21 and the second housing element 22 are connected to each other in the form of a common interior of the housing not shown in FIG. 1.

For example, a plurality of battery cells 3 and a control element 7 of the battery module 1 are accommodated in such an interior.

Furthermore, a first power bus 51 and a second power bus 52 are accommodated in the interior.

An opening 6 is provided in the housing 2. According to the illustration in FIG. 1, the opening 6 is closed by means of a closure element 60, in particular with a cover 600.

Furthermore, an overall voltage tap 100 of the battery module 1 can be seen.

FIG. 2 shows a sectional view of a battery module 1 prior to the formation of the electrically conductively formed connection.

Firstly, a first power bus 51 can be seen, which is electrically conductively connected to a voltage tap 6 of a terminally arranged battery cell 31 of a plurality of battery cells 3. The plurality of battery cells 3 are electrically conductively connected in series and/or in parallel to each other by means of so-called cell connectors 30.

Furthermore, a second power bus 52 can be seen, which is electrically conductively connected to a control unit 7 of the battery module 1.

In particular, it can be seen from FIG. 2 that the plurality of battery cells 3 and the control unit 7 as well as the first power bus 51 and the second power bus 52 are accommodated within the housing 2 of the battery module 1.

Furthermore, it can already be seen from FIG. 2 that the first power bus 51 and the second power bus 52 are arranged in such a way that a mechanical connection 8 can be formed between the first power bus 51 and the second power bus 52 in such a way that an electrically conductively formed connection can be formed between the first power bus 51 and the second power bus 52.

It can also be seen that the opening 6 is arranged continuously through the housing 2.

Furthermore, a cap nut 91 is also shown, which forms a thread 9.

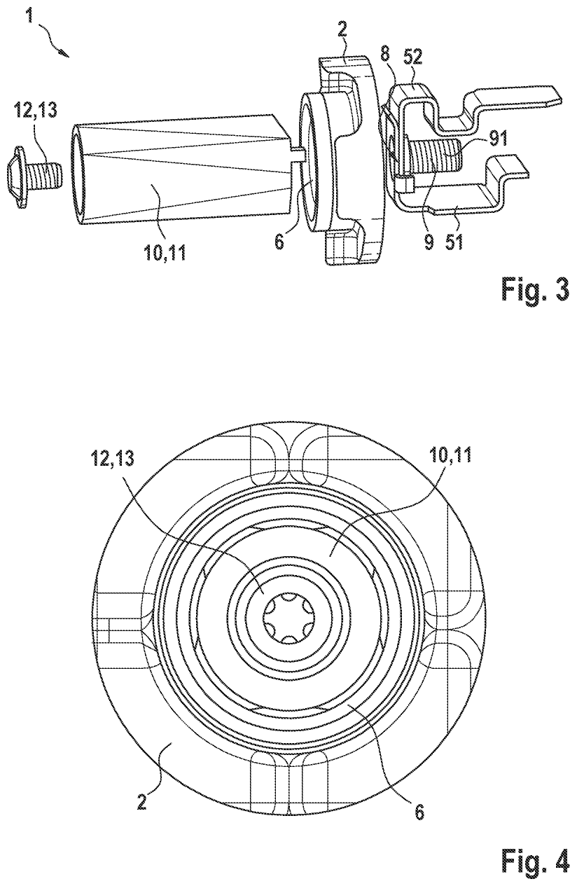

FIG. 3 shows a perspective view of the essential elements of the method for forming an electrically conductively formed connection.

Firstly, the first power bus 51 and the second power bus 52 are shown. Furthermore, the cap nut 91 already shown in FIG. 2, which forms the thread 9, can also be seen.

In addition, the mechanical connection 8 is already indicated.

Firstly, a mounting aid 10, which is configured as a mounting sleeve 11 as shown in FIG. 3, is inserted into the opening 6 of the housing 2.

In addition, a connecting element 12, which is configured as a screwing element 13 as shown in FIG. 3, is accommodated in the mounting aid 10. In particular, the mounting aid 10 is inserted into the opening 6 in such a way that the mounting aid 10 or the mounting sleeve 11 rests on the entire surface of the first power bus 51.

The connecting element 12 can be guided through the mounting aid 10 or in the mounting aid 10 or by means of the mounting aid 10 to the connection point between the first power bus 51 and the second power bus 52, such that the connecting element 12 forms the mechanical connection 8 between the first power bus 51 and the second power bus 52 in such a way that an electrically conductively connection is also formed between the first power bus 51 and the second power bus 52.

In particular, the connecting element 12, which is configured as a screw element 13, engages in the thread 9 of the cap nut 91 in order to form the mechanical connection 8.

It can be seen from FIG. 3 that the first power bus 51 and the second power bus 52 are arranged between the cap nut 91 and the mounting aid 10.

It should be noted at this point that it is also possible that the first power bus 51 and/or the second power bus 52 can form the thread 9, which is not shown in the figures.

FIG. 4 shows a screwing process for forming the mechanical connection 8. The connecting element 12 configured as a screwing element 13 as well as the mounting aid 10 configured as a mounting sleeve 11 and the opening 6 of the housing 2 can be seen here.

To form the mechanical connection 8, the screwing element 13 engages in the thread 9.

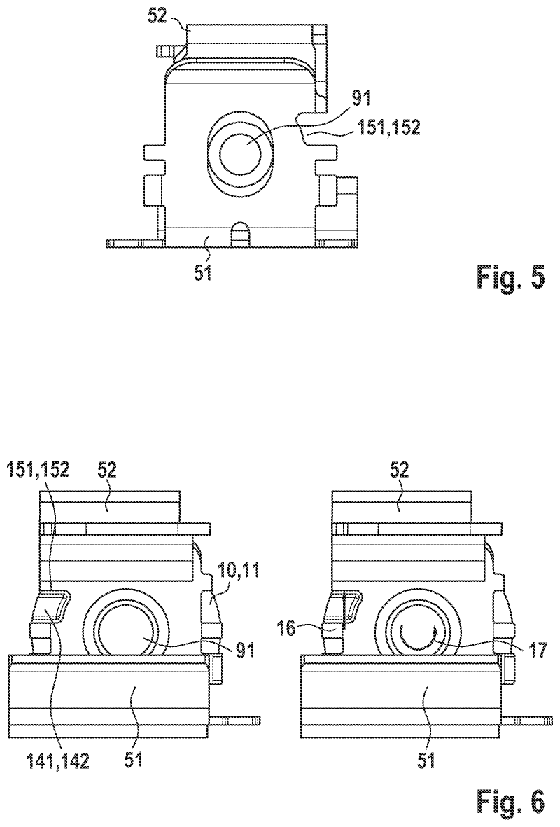

FIG. 5 shows a first power bus 51 and a second power bus 52 prior to forming the mechanical connection 8. In addition, the cap nut 91 can also be seen.

Furthermore, a second securing element 151 of the first power bus 51 and/or the second power bus 52 can also be seen.

In particular, the second securing element 151 is configured as a recess 152.

FIG. 6 shoes a screwing process for forming the mechanical connection 8.

The left-hand diagram shows a state prior to the formation of the screw connection, while the right-hand diagram shows a state during or after the configuration of the screw connection.

Firstly, the first power bus 51 and the second power bus 52 can be seen. The cap nut 91 is also shown. Furthermore, the mounting aid 10 can also be seen, which is in particular configured as a mounting sleeve 11.

Furthermore, the second securing element 151 of the first power bus 51 and/or the second power bus 52, which is configured as a recess 152 as shown in FIG. 6, is also shown.

In addition, the mounting aid 10 or the mounting sleeve 11 comprises a first securing element 141, which is configured as a securing pin 142 as shown in FIG. 6.

It can be seen here that the first securing element 141 of the mounting aid 10 engages in the second securing element 151 of the first power bus 51 or the second power bus 52.

According to the left-hand illustration of FIG. 6, the first securing element 141 of the mounting aid 10 is arranged in a neutral position, wherein in this neutral position the first securing element 141 has no contact to a support element 16 of the second securing element 142.

If during the assembly process or screwing process, the assembly aid 10 is now rotated about its longitudinal axis, the first securing element 141 comes to rest against the support element 16 of the second securing element 142, as shown in the right-hand illustration of FIG. 6.

This now allows the first power bus 51 and the second power bus 52 to be supported on the mounting aid 10 when applying the tightening torque 17 to form the screw connection. This prevents the other connections of the first power bus 51 and/or the second power bus 52, in particular the welded connections, from being stressed and damaged by the tightening torque 17.

1. A method for forming an electrically conductively formed connection between a first power bus (51) which is electrically conductively connectable or connected to a voltage tap (6) of a terminally arranged battery cell (31) of a plurality of electrically conductively interconnected battery cells (3), and
a second power bus (52) electrically conductively connectable or connected to a control unit (7) of a battery module (1), wherein
the plurality of battery cells (3), the control unit (7) as well as the first power bus (51) and the second power bus (52) are accommodated in a housing (2) of the battery module (1), wherein
an opening (6) is provided in the housing (2), and
a mounting aid (10) is inserted into the opening (6), and furthermore a connecting element (12) is accommodated in the mounting aid (10),
and via the connecting element (12), a mechanical connection (8) between the first power bus (51) and the second power bus (52) is formed such that an electrically conductive connection is formed between the first power bus (51) and the second power bus (52).

2. The method according to claim 1, wherein the opening (6) is arranged continuously through the housing (2).

3. The method according to claim 1, wherein the mounting aid (10) is inserted into the opening (6) such that the mounting aid (10) rests on the first power bus (51) and/or the second power bus (52).

4. The method according to claim 1, wherein the mounting aid (10) is configured as a mounting sleeve (11).

5. The method according to claim 1, wherein the connecting element (12) is configured as a screwing element (13), which engages in a thread (9) to form the mechanical connection (8).

6. The method according to claim 5, wherein a cap nut (91) forms the thread (9), wherein the first power bus (51) and the second power bus (52) are arranged between the cap nut (91) and the mounting aid (10).

7. The method according to claim 5, wherein the first power bus (51) and/or the second power bus (52) form the thread (9).

8. The method according to claim 5, wherein a first securing element (141) of the mounting aid (10) and a second securing element (151) of the first power bus (51) and/or the second power bus (52) interlock in a manner that does not exceed a permissible tightening torque (17).

9. The method according to claim 8, wherein the first securing element (141) is configured as a securing pin (142) and the second securing element (151) is configured as a recess (152).

10. A battery module comprising:
a plurality of battery cells (3) and a control unit (7) as well as a first power bus (51) and a second power bus (52), accommodated in a housing (2) of the battery module (1), wherein the first power bus (51) is electrically conductively connectable or connected to a voltage tap (6) of a terminally arranged battery cell (31) of the plurality of electrically conductively connected battery cells (3), and
the second power bus (52) is electrically conductively connectable or connected to the control unit (7) of the battery module (1),
wherein
an opening (6) is provided in the housing (2), and
the opening (6) is configured to receive a mounting aid (10), and a connecting element (12) forms a mechanical connection (8) between the first power bus (51) and the second power bus (52) such that an electrically conductively formed connection is formed between the first power bus (51) and the second power bus (52).

11. The method according to claim 3, wherein the mounting aid (10) rests over an entire surface on the first power bus (51) and/or the second power bus (52).
